(19) United States
(12) Patent Application Publication
(10) Pub. No.: US 2015/0344284 A1
(43) Pub. Date: Dec. 3, 2015

(54) AUTOMATIC FLUID DISPENSER

(71) Applicant: Tended Bar LLC, Franklin, TN (US)

(72) Inventor: James Perkins, Franklin, TN (US)

(21) Appl. No.: 14/724,691

(22) Filed: May 28, 2015

Related U.S. Application Data
(60) Provisional application No. 62/003,746, filed on May 28, 2014.

(51) Int. Cl. B67D 1/08; B67D 1/10; B67D 1/00

(52) U.S. Cl. CPC B67D 1/0888; B67D 1/0041; B67D 1/0035; B67D 1/10

(57) ABSTRACT

The present disclosure generally relates to an automatic fluid dispenser.

### CROSS-REFERENCE TO RELATED APPLICATIONS

This application claims the benefit of U.S. Provisional Application No. 62/003,746, filed May 28, 2014, the disclosure of which is expressly incorporated by reference herein.

### FIELD OF THE DISCLOSURE

The present disclosure generally relates to an automatic fluid dispenser. More particularly, the present disclosure relates to an automatic fluid dispenser configured to mix and dispense beverages such as alcoholic beverages having target amounts of alcoholic and non-alcoholic fluid wherein each amount is sufficient to make a particular alcoholic beverage.

### BACKGROUND OF THE DISCLOSURE

Liquor is typically manually dispensed directly into a beverage container from a liquor bottle. However, in such an operation the individual dispensing the liquor is apt to pour a greater amount than needed to make a particular alcoholic beverage or to spill the liquor during the dispensing process. Mechanical devices, such as a jigger, may be used to pour a particular amount of liquor. However, such mechanical devices require close attention by the user and, if not properly used, could result in spillage of the liquor to be dispensed. The owner of a home or establishment providing liquor to guests or patrons will likely suffer financial loss due to spilled or lost liquor. Examples of other known dispensing systems are contained in the following patents: U.S. Pat. Nos. 3,170,597; 3,599,833; and 3,688,947.

Manual actuation and dispensation of various liquor containers or bottles have caused increased time in making certain beverages. Additionally, prior art pouring spouts used in connection with liquor bottles are relatively bulky and expensive and are difficult to maintain in the proper operating condition. Thus, a need exists for an automatic fluid dispenser that may be installed into a home or business to expeditiously make and mix various drinks, including alcoholic drinks. Likewise a need exists for an automatic fluid dispenser that produces mixed beverages, such as alcohol beverages, in a consistent manner such that taste and quality are improved and enhanced over current manual processes.

### SUMMARY OF THE DISCLOSURE

In an exemplary embodiment of the present disclosure, an automatic fluid dispenser is provided including a housing, an electronic controller disposed within the housing, a dispensing outlet coupled to the housing, and a plurality of pumps coupled to the electronic controller and positioned within the housing. Each pump is configured to move a different alcoholic fluid from a corresponding fluid storage container to the dispensing outlet. The automatic fluid dispenser includes a dispenser device including a plurality of selectable inputs corresponding to a plurality of non-alcoholic fluids, and the dispenser device is operative to move a non-alcoholic fluid to the dispensing outlet based on selection of a selectable input. The automatic fluid dispenser includes an interface supported by the housing and in communication with the electronic controller. The interface is configured to receive one or more inputs wherein at least one of the inputs causes the electronic controller to provide a signal to at least one pump to cause movement of an alcoholic fluid from the fluid storage container to the dispensing outlet and a signal to the dispenser device to cause movement of the non-alcoholic fluid to the dispensing outlet. The dispensing outlet is configured to simultaneously dispense a predetermined amount of the alcoholic fluid and a predetermined amount of the non-alcoholic fluid to a fluid receiving container.

In another exemplary embodiment of the present disclosure, an automatic fluid dispenser is provided including an electronic controller, at least one pump coupled to the electronic controller, the at least one pump configured to move a first fluid from a first fluid storage container to an outlet, a dispenser device including a plurality of selectable inputs corresponding to a plurality of fluids, the dispenser device being operative to move a second fluid to the outlet in response to a selection of a selectable input, a user interface coupled to the electronic controller, the user interface including a display and being configured to receive a user input corresponding to a fluid mixture selection and to output a signal indicative of a fluid mixture selection, and a scanning device communicably coupled to the electronic controller and the display, the scanning device configured to identify a known device. The electronic controller is operative to provide one or more control signals to the at least one pump and to the dispenser device to cause the automatic fluid dispenser to dispense a predetermined amount of the first fluid and a predetermined amount of the second fluid through the outlet in response to the scanning device identifying the known device and the user interface providing the signal indicative of the fluid mixture selection.

In yet another exemplary embodiment of the present disclosure, a fluid dispensing system is provided including at least one processor and memory containing instructions that when executed by the at least one processor cause the at least one processor to provide a first user interface viewable on a display, the first user interface comprising selectable data representing a plurality of fluid selections including at least one of an alcoholic fluid mixture selection and a non-alcoholic fluid selection. The system further includes at least one pump in communication with the processor, the at least one pump configured to move an alcoholic fluid from a fluid storage container to an outlet based on a user selection of an alcoholic fluid mixture selection provided via the first user interface. The system includes a dispenser device operative to move a non-alcoholic fluid to the outlet based on the user selection of the alcoholic fluid mixture selection provided via the first user interface. The processor is operative to provide one or more control signals to the at least one pump and to the dispenser device to cause the automatic fluid dispenser to simultaneously dispense a predetermined amount of the alcoholic fluid and a predetermined amount of the non-alcoholic fluid through the outlet in response to the user selection of the alcoholic fluid mixture selection provided via the first user interface.

In still another exemplary embodiment of the present disclosure, a method in a fluid dispensing system is provided including: receiving, via a human-machine interface, at least one input, the at least one input indicating a desired fluid mixture selection; in response to the receiving, providing, via an electronic controller, at least one control signal to at least one pump, the pump configured to move a first fluid from a fluid storage container to an outlet; in response to the receiving, providing, via the electronic controller, at least one control signal to a dispenser device, the dispenser device being operative to move a second fluid to the outlet; and dispensing, via the outlet, a predetermined amount of the first fluid and a predetermined amount of the second fluid corresponding to the desired fluid mixture selection, the dispensed fluid mixture being received by the fluid receiving container.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is an exemplary automatic fluid dispenser according to the present disclosure;

FIG. 2 is a functional block diagram representative of one or more systems and components of the automatic fluid dispenser of FIG. 1 according to some embodiments;

FIG. 3 is a another functional block diagram representative of one or more systems and components of an alternative embodiment of the automatic fluid dispenser of FIG. 1 according to some embodiments;

FIG. 4A is an exemplary electronic controller for controlling one or more components of the automatic fluid dispenser of FIG. 1;

FIG. 4B is an exemplary terminal block for receiving wires and routing signals to one or more components of the automatic fluid dispenser of FIG. 1;

FIG. 5 is an exemplary rack for receiving and supporting one or more fluid storage containers according to the present disclosure;

FIG. 6A is an exemplary pump for moving fluid from a fluid storage container to a fluid receiving container in accordance with the present disclosure;

FIG. 6B is an exemplary valve for facilitating fluid flow through a fluid supply hose of the automatic fluid dispenser of FIG. 1;

FIG. 7A illustrates an exemplary fluid storage container with an exemplary fluid supply hose attached thereto according to the present disclosure;

FIG. 7B illustrates a plurality of exemplary fluid storage containers for use in the automatic fluid dispenser of FIG. 1 according to the present disclosure;

FIG. 8 is an exemplary large scale network schematic including a plurality of the displays, electronic controllers, and computing devices for use with multiple automatic fluid dispensers;

FIG. 9 illustrates an exemplary dispenser including a dispensing outlet for use in the automatic fluid dispenser of FIG. 1 for dispensing multiple different fluids;

FIG. 10 illustrates an enlarged view of an exemplary cylinder and an enlarged view of the dispenser of FIG. 9 including a plurality of cylinders used to engage a plurality of buttons on the dispenser;

FIGS. 11A, 11B, 11C, and 11D each illustrate exemplary user interfaces viewable on a display of the automatic fluid dispenser of FIG. 1;

FIG. 12 illustrates another exemplary user interface viewable on a display of the automatic fluid dispenser of FIG. 1;

FIG. 13 illustrates an exemplary automatic fluid dispenser disposed in a mobile serving structure according to the present disclosure; and

FIG. 14 illustrates a flow diagram of an exemplary method of operating the automatic fluid dispenser of FIG. 1 and the automatic fluid dispenser of FIG. 13 according to some embodiments.

### DETAILED DESCRIPTION OF EMBODIMENTS

The embodiments disclosed herein are not intended to be exhaustive or to limit the disclosure to the precise forms disclosed in the following detailed description. Rather, the embodiments were chosen and described so that others skilled in the art may utilize their teachings.

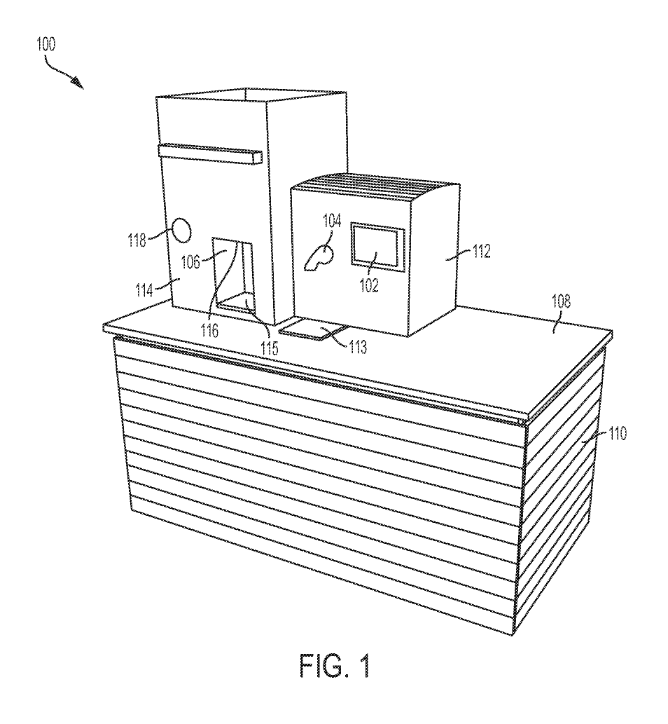

FIG. 1 is an automatic fluid dispenser 100 according an illustrative embodiment of the present disclosure. Automatic fluid dispenser 100 may also be referred to herein as bar 100 or tended bar 100. Bar 100 generally includes display 102, first outlet 104, cavity 106, counter 108, base 110, first section 112, second section 114, dispenser 116, first pad 113, second pad 115 and scanning device 118. In one embodiment, dispenser 116 is configured to dispense both ice and fluids. As illustrated, counter 108 is disposed atop and supported by base 110, and first section 112 and second section 114 are disposed atop and supported by counter 108. As described in further detail herein, bar 100 is configured to dispense a variety of fluids in response to one or more user inputs indicating a desired beverage, drink or fluid selection. In the illustrated embodiment, the fluids include alcoholic fluids and non-alcoholic fluids. The alcoholic fluids include beverages having only a liquor based fluid as well as various mixed beverages containing a certain percentage of liquor based fluids and a certain percentage of one or more non-alcoholic fluids. Non-alcoholic fluids may include a variety of drinks or beverages, such as water, various flavored carbonated drinks, soda, and various fruit flavored drinks, for example. Liquor based fluids include a wide variety of liquors including vodka, rum, gin, whiskey, bourbon, scotch, tequila, beer, brandy, and other suitable liquors. In one embodiment, the alcoholic fluids further include wine and beer.

In operation, a user desiring a particular fluid selection positions a fluid receiving container atop first pad 113 and below first outlet 104, the user inputs the desired selection via display 102, and bar 100 then dispenses, via first outlet 104, the desired fluid selection in response to the user inputting the desired selection. In one embodiment, bar 100 may simultaneously dispense one or more desired fluid selections wherein a first desired fluid selection is dispensed from first outlet 104 while a second desired fluid selection is dispensed from dispenser 116. Thus, bar 100 automatically dispenses a desired fluid selection in response to one or more user inputs received via display 102. In the illustrative embodiment of FIG. 1, counter 108, base 110, first section 112, and second section 114 cooperate to form enclosures or a serving structure configured to house a plurality of components that comprise automatic fluid dispenser 100.

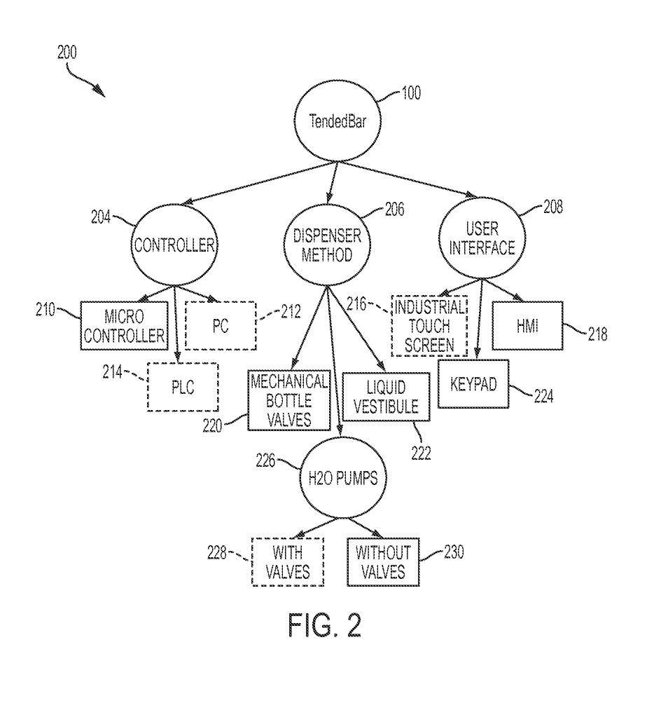

In the illustrated embodiment, display 102 includes a graphical user interface including a touchscreen configured to receive user inputs and route corresponding input signals to a controller (see FIG. 2) for controlling bar 100. In one embodiment, display 102 and/or controller 204 (FIG. 2) are locked out from dispensing operations until controller 204 verifies an identity of the user. For example, scanning device 118 is configured to identify an authentication code and/or user device to verify the user identity. In one embodiment, scanning device 118 is a radio frequency identification (“RID”) scanner configured to identify a device such as an RID tag that, when positioned within close proximity to scanning device 118, emits an IF signal of a known frequency. Thus, in this embodiment, a known user device includes an RID tag that identifies the user based on the known frequency. In one embodiment, the RID tag is disposed on a bracelet worn by the user. In one embodiment, display 102 includes an industrial touch screen display and may include a human-machine interface (“HMI”) comprising a plurality of digitally displayed imagery and selectable data designed and programmed to allow the user to input a variety of commands indicating desired fluid selections that are dispensed by bar 100. In various embodiments of the present disclosure, display 102 is industriously designed and structured to be resistant to water and various other fluids thereby preventing fluid penetration and mitigating damage or malfunction of electronic components that comprise display 102.

FIG. 2 is a functional block diagram representative of one or more systems and components of the automatic fluid dispenser of FIG. 1. As described in detail below, bar 100 generally includes a user interface 208 and a controller 204 configured to implement a dispenser method 206. Controller 204 may include one or more of a microcontroller 210, a programmable controller (analog) 212, and a programmable logic controller (digital) 214. Dispenser method 206 may be selected from a group of dispensing methods including mechanical bottle valves 220, one or more liquid vestibules 222, and one or more pumps 226. Pumps 226 include fluid pumps with integrated valves 228 and fluid pumps without integrated valves 230. Likewise, user interface 208 may be selected from a group of exemplary user interfaces including an industrial touch screen 216, an HMI 218, and a keypad 224. As is known in the art and in various exemplary embodiments of the present disclosure, user interface 208 may generally comprise one or more input/output (“I/O”) modules which provide an interface between a user or operator and, for example, display 102 of bar 100. Exemplary I/O includes, for example, one or more inputs provided by users or operators and one or more viewable data output or displayed via display 102. User inputs may be provided by exemplary input modules including buttons, switches, keys, a touch display, a keyboard, a mouse, and other suitable devices for providing information to display 102. Exemplary outputs may be displayed or provided to a user via exemplary output modules including lights and light-emitting-diodes, a display (such as a touch screen display), a printer, a speaker, visual devices, audio devices, tactile devices, and other suitable devices for presenting information to an operator or user.

In an exemplary preferred embodiment, a programmable logic controller (hereinafter “PLC”) 214 is the selected controller 204 used to provide one or more signals for controlling the various components that comprise bar 100. Although in certain embodiments PLC 214 may be the preferred controller 204, other suitable controllers may be used and such other suitable controllers are not limited to microcontroller 210 and programmable controller 212. PLC 214 generally includes a processor and memory. The processor may comprise a single processor or may include multiple processors, located either locally with PLC 214 or accessible across a computing network. The memory is a computer readable medium and may be a single storage device or may include multiple storage devices, located either locally within PLC 214 or accessible across a computing network. Computer-readable media may be any available media that may be accessed by the processor and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by PLC 214.

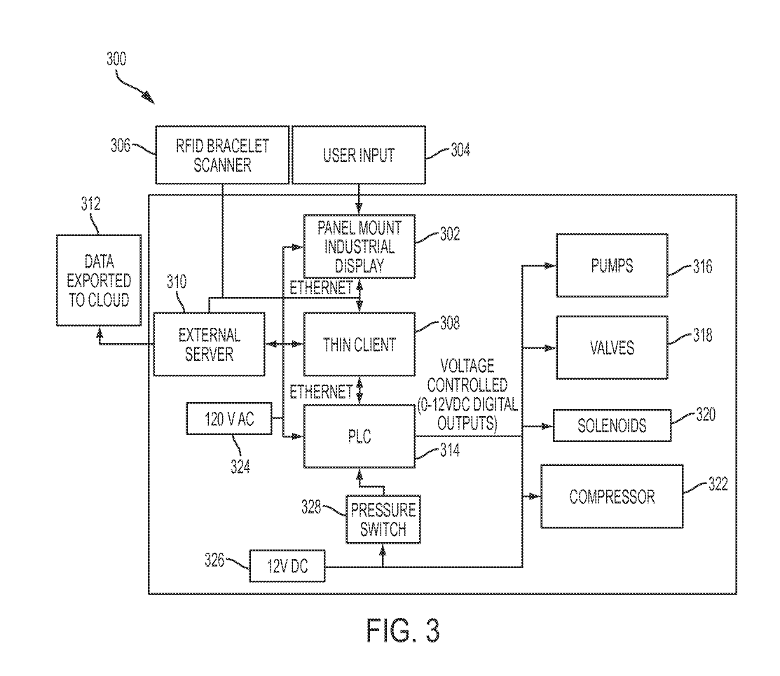

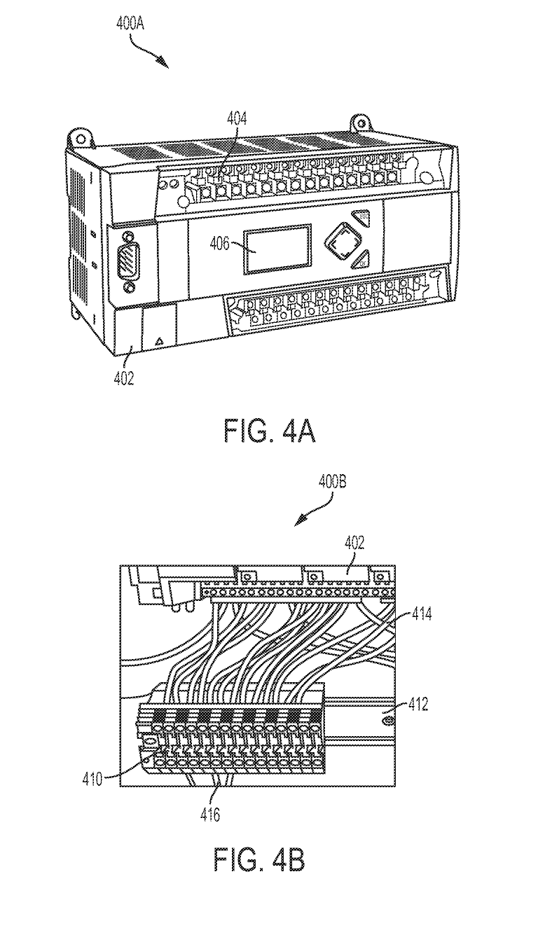

As described in more detail in the illustrative embodiment of FIG. 3, PLC 314 (214 of FIG. 2) may communicate user input data, fluid selection data, dispensed fluid data, system status information, or a combination thereof to a computing device or remote server device for analysis and/or storage. The computing network may include a local area network, a public switched network, a closed area network, a wide area network and any other type of wired or wireless computing network. FIG. 4A illustrates an exemplary electronic controller 400A in the form of a PLC 402. In one embodiment, exemplary PLC 402 is a physical representation of PLC 214 (FIG. 2) and may be procured under model name MicroLogix™1400 manufactured by Allen-Bradley®. PLC 402 is generally designed and configured to provide a plurality of digital voltage and current signals as well as analog voltage signals which may be used to control one or more components of bar 100. In one embodiment, PLC 402 includes a plurality of I/O connection ports 404 and a built-in backlight Liquid Crystal Display (“LCD”) display 406. Exemplary PLC 402 generally includes up to 7 expansion I/O modules for a maximum of 256 discrete or digital I/O and an Ethernet port providing EtherNet/IP, DNP2 over IP and Modbus TCP/IP protocol support as well as web server and email capabilities. In one embodiment, display 102 (FIG. 1) and/or any one of the exemplary user interfaces 208 (FIG. 2) are configured to communicate with the PLC 402 via the Ethernet network communication protocol.

FIG. 4B illustrates an exemplary terminal block layout 400B of PLC 402 for receiving one or more signal wires and to facilitate routing the signal wires to one or more components of bar 100. Layout 400B generally includes terminal block 410, first signal wires 414, rail 412, and second signal wires 416. Although a single terminal block 410 and a single rail 412 are shown in the illustrative embodiment of FIG. 4B, it should be understood that multiple terminal blocks 410 and rails 412 may be used in various alternative embodiments of the present disclosure. In one embodiment, PLC 402, terminal block 410 and a power supply are mounted and secured onto rails 412. In this embodiment, rail 412 is mounted within an internal section of base 110 to ensure that one or more electronic components that comprise bar 100 share a common ground. In various embodiments, first signal wires 414 are run from the outputs of PLC 402 to input slots on terminal block 410 mounted to rail 412. Terminal block 410 generally snaps onto rail 412 with a relatively moderate amount of pressure. First signal wires 414 and second signal wires 416 should all be cut to an appropriate length to ensure the wires are neat, organized and sufficiently secure to mitigate chaffing concerns. In one embodiment, COM+ and COM− output wires must be routed to a cluster of terminal blocks that are jumpered together. The cluster of jumpered terminal blocks is connected to the +12 VDC and −12 VDC power supply respectfully.

Referring again to FIG. 2, in an exemplary preferred embodiment according to the present disclosure, fluid pump 226 without integrated valves 230 is the selected dispensing method 206 used to pump or move fluid from an exemplary fluid storage container to, for example, first outlet 104 of bar 100 (FIG. 1). Although in certain embodiments pump 226 may be the preferred dispensing method 206, other suitable dispensing methods may be used and such other suitable methods are not limited to mechanical bottle valves 220 and liquid vestibule 222. In one embodiment, bar 100 of FIG. 1 is configured to provide more than one dispensing method 206, and the dispensing method 206 is selectable by a user. Table 1 illustrated below provides a general description of exemplary capabilities of the exemplary dispenser methods disclosed in FIG. 2.

TABLE 1
Exemplary Dispenser methods

| Method | Notes |
|---|---|
| Bottle valves | Fast dispensing, can monitor |
| | what is being dispensed |
| H2O Pumps Single | Can monitor the even flow of the fluid. Works |
| Valves | with all types of liquors. Stays sealed. Consistent |
| | pours no matter what level of fluid is remaining in |
| | the exemplary fluid storage container |
| H2O Pumps without | Can monitor the even flow of the fluid. Works |
| valves | with all types of liquors, not sealed, may need |
| | periodic recalibration in some embodiments |
| Liquid | Can dispense the same amount of fluid each |
| Vestibules | dispensing event regardless of large or small |
| | amounts of fluid remaining in the storage container |

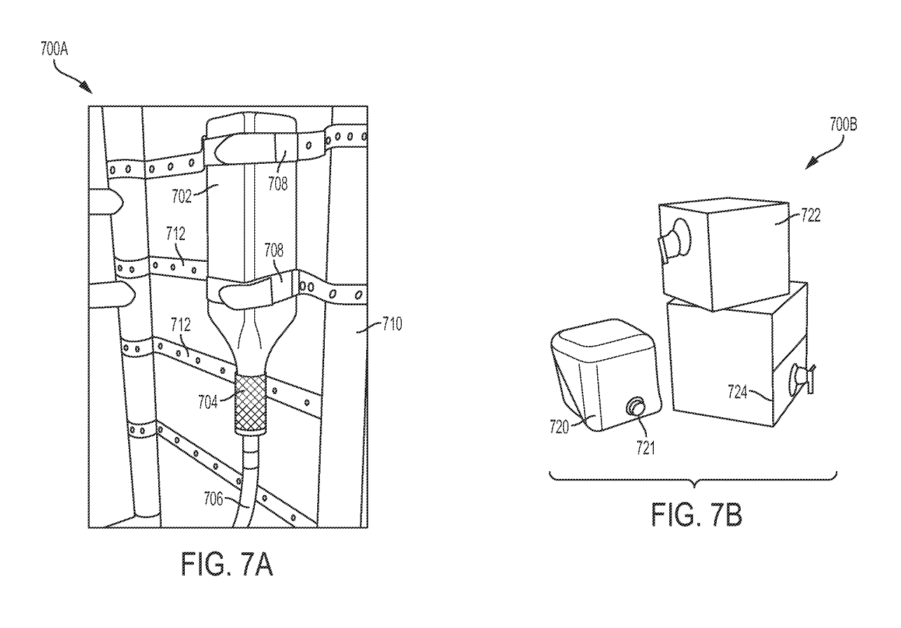

In one embodiment, bar 100 includes a single pump 226 or a plurality of pumps 226. In one embodiment, each pump 226 is a single direction fluid pump configured to move fluid uni-directionally from a first fluid storage container to, for example, a fluid receiving container. Base 110 may include one or more internal sections or compartments structured to receive one or more components that comprise bar 100. Pumps 226 may be generally disposed within an exemplary compartment or internal section of base 110. Pumps 226 may be positioned generally below inverted fluid storage containers (see FIG. 7A) wherein the inverted storage containers dispense fluid based on the assistance of gravity and the suction energy created by pump 226. Hence, pumps 226 are positioned below inverted fluid storage containers to ensure sufficient amounts of fluid are present such that pump 226 is adequately prime and able to pump fluid up to and out of first outlet 104. In one embodiment, pumps 226 are designed to move or pump approximately 6 gallons of fluid per minute (“GPM”).

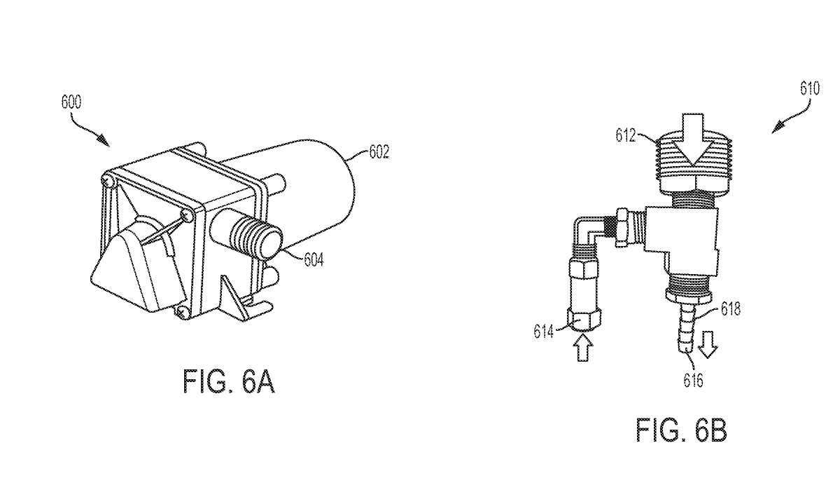

Referring now to the illustrative embodiment of FIG. 6A, an exemplary fluid pump 600 is illustrated. In one exemplary embodiment, pump 600 is a physical representation of pump 226 (FIG. 2), is approximately 3″×4″×5″, and is designed to operate based on application of 12 VDC and 2 Amps. Pump 600 generally includes a pump section 602, a fluid inlet 604 and a fluid outlet (not shown). In an exemplary embodiment, bar 100 includes eight pumps disposed within an internal section of base 110, although any suitable number of pumps may be provided. Referring now to the illustrative embodiment of FIG. 6B, an exemplary valve 610 is shown including a one way check valve (“CV”) 614, a bushing for a container without vinyl tubing 612, and an outlet 616 including hose barb 618. In various embodiments, valve 610 is installed onto an exemplary fluid storage container such as container 702 (FIG. 7A) by way of bushing 612. One way CV 614 is configured to allow air into fluid storage container 702 but not to allow fluid to exit container 702 except when pump 600 is activated. Hence, use of CV 614 avoids the need to run lines to the bottom of container 702 (FIG. 7A) to let air into the container. In one embodiment, bushing 612 and outlet fitting 616 are covered with Teflon tape to prevent or mitigate fluid leaks where bushing 612 interfaces with the opening of container 702 (FIG. 7A) and where outlet 616 interfaces with one end of a fluid supply hose. In one embodiment, the use of the air vent via CV 614 reduces the likelihood that a vacuum will be created that would cause liquid to continue to flow even after the pump is turned off.

As illustrated in the embodiment of FIG. 7A, inverted container layout 700A includes a first exemplary fluid storage container 702 in an inverted orientation with a spout 704 affixed to the outlet of container 702 and a first fluid supply hose 706 affixed to spout 704. Although one way CV 614 is not shown in the illustrative embodiment of FIG. 7A, it should be understood that in one or more alternative embodiments one way CV 614 may be coupled to an exemplary fluid storage container as described above. Although not illustrated in FIG. 7A, pump 600 may be positioned below inverted fluid storage container 702 while fluid supply hose 706 provides a flow medium for fluid to move from container 702 to pump 600 and from pump 600 to first outlet 104 of bar 100.

In one embodiment, layout 700A and pump 600 are assembled as follows: couple spout 704 to the open end of first fluid storage container 702, couple one end of a first section of fluid supply hose 706 to spout 704 and the other end to fluid inlet 604 of pump 600 (FIG. 6A), couple one end of second section of fluid supply hose 706 to the fluid outlet of pump 600 and the other end of hose section 706 to a dispenser. In one embodiment, the second section of fluid supply hose 706 extends several feet (e.g., two to four feet) in a longitudinally upward direction to the dispenser positioned above. The container 702 is then inverted and secured to exemplary internal wall section 710 via one or more fasteners 708 (illustratively flexible straps) affixed to sections 712, and pump 600 is connected to a 12VDC power supply line from PLC 402.

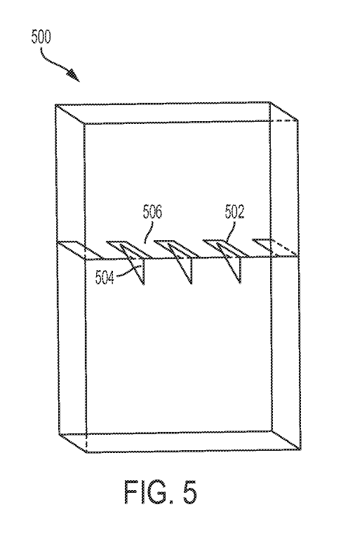

The illustrative embodiment of FIG. 7B shows one or more exemplary alternative fluid storage containers 700B. Fluid storage container 720 includes opening 721 for affixing spout 704 (FIG. 7A). FIG. 7B further illustrates an exemplary fluid storage container enclosed by box 722 and another larger exemplary fluid storage container enclosed by box 724, each including an opening or port. Additionally, FIG. 5 illustrates an exemplary rack 500 including a plurality of rack sections 502 for supporting fluid storage containers and corresponding section supports 504 for each rack section 502. Rack 500 may be constructed from a variety of materials including various metals, alloys, woods and any combination thereof. In one embodiment, rack 500 is disposed in the interior of base 110 (FIG. 1) and provides a means for securing one or more exemplary fluid storage containers such as container 702. In one embodiment, a single fluid storage container is disposed within each gap 506 in an inverted orientation.

Referring again to FIG. 3, another functional block diagram of an automatic fluid dispensing system 300 is illustrated according to some embodiments. System 300 includes panel mount industrial display 302 (e.g., display 102 of FIG. 1), user input device(s) 304, RID scanner 306, computing device 308, external server 310, and data exported to cloud 312. System 300 further includes PLC 314, pumps 316 (e.g., pump 600 of FIG. 6A), electronically actuated valves 318, solenoids 320, compressor 322, 120V AC supply 324,12V DC supply 326 and pressure switch 328. In one embodiment, computing device 308 is a thin client personal computer. In an alternative embodiment, computing device 308 is a conventional personal computer including a local hard drive, a plurality of software applications, sensitive data and a plurality of random access memory modules for real-time data processing. It should be understood that the description of system 300 is directed primarily toward the electronic, computing and networking aspects of the one or more components that comprise bar 100.

In the illustrative embodiment of FIG. 3, system 300 is powered via a conventional wall outlet configured to supply 120V AC 324. In particular, supply 324 provides power directly to PLC 314, computing device 308, industrial display 302, and external server 310. Industrial display 302, external server 310, computing device 308, RID scanner 306, and PLC 314 form a group of devices that are configured to exchange data communications with other devices in the group via the Ethernet network communication protocol. In one embodiment, an Ethernet switch is installed within an internal section of base 100 wherein PLC 314, computing device 308, and industrial display 302 are communicably coupled to the Ethernet switch via conventional Ethernet cable. Additionally, RID scanner 306 may be powered via, for example, an Ethernet connection with PLC 314. PLC 314 includes internal circuitry that steps down the 120V AC power provided from supply 324 in order to supply 12V DC to various auxiliary components via one or more discrete signals.

In one embodiment, auxiliary components include solenoid 320 and compressor 322. 12V DC supply 326 provides power directly to pumps 316 and valves 318. PLC 314 communicates with various components of system 300 (e.g., industrial display 302, computing device 308, RID scanner 306, database/external server 310 and an exemplary point of sale system) via the Ethernet network communications protocol. In one embodiment, system 300 may be accessed remotely via a computing network such that a user having system administrative privileges may monitor all relevant statistics and system information including, for example, quantity and type of dispensed fluid selections, quantity of fluid remaining in one or more fluid storage containers, and type(s) of fluid selections that are the most popular among the various users of bar 100. In another embodiment, external server 310 transmits all relevant statistics and system information as data exported to cloud 312 and the system administrator may remotely access data 312 in order to view and analyze certain statistics and system information.

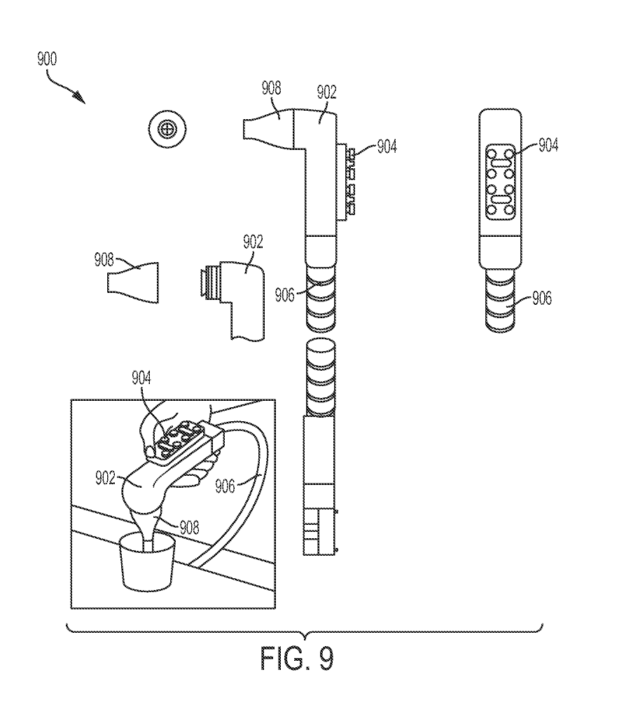

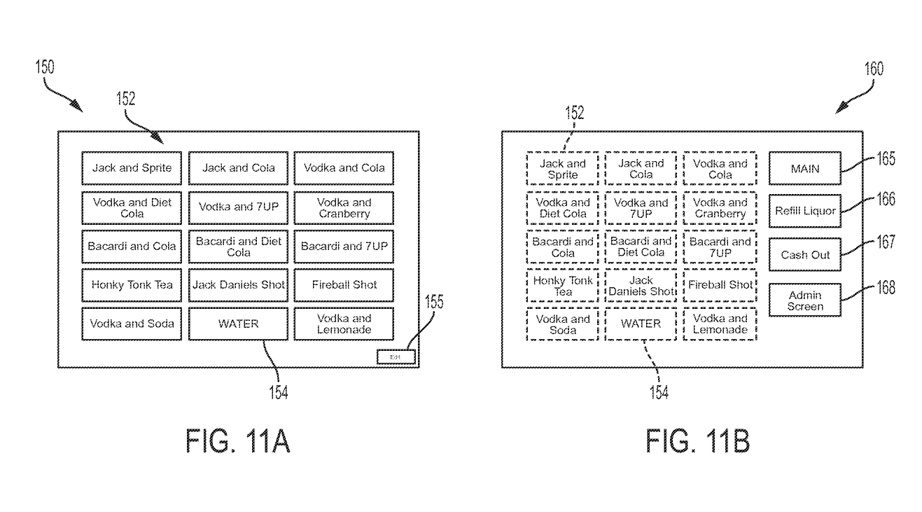

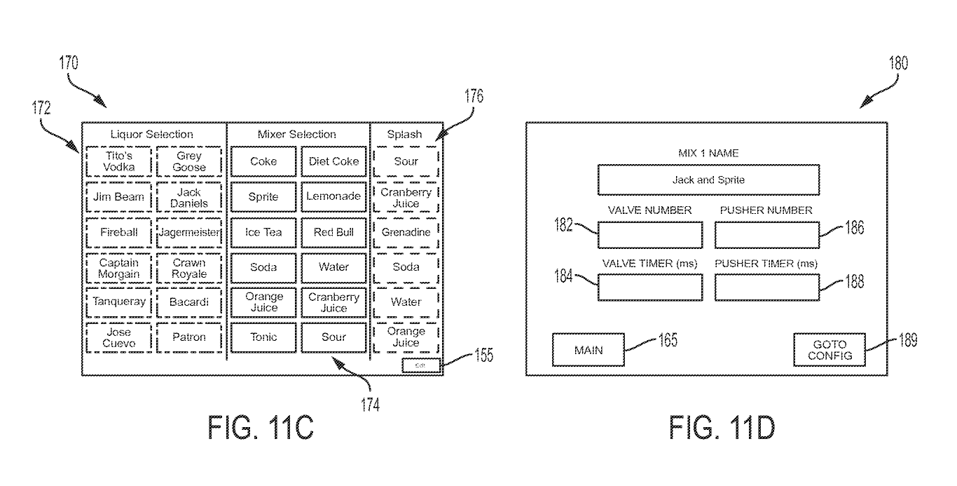

In one embodiment, system 300 operates as follows: industrial display 302 receives a fluid selection from a user (see fluid selections of FIGS. 11A-11D) and communicates the user's selection to PLC 314 and to other networked devices such as computing device 308 via the Ethernet protocol; PLC 314 receives the signal indicative of the user's selection and based on that selection determines which pumps 316 require activation (e.g., based on a lookup table stored in memory containing drink recipes); PLC 314 provides a control signal to selectively activate or turn-on pumps 316 based on the retrieved recipe, actuates or opens valves 318, and actuate or extend solenoids 320 for a predetermined amount of time to allow for the one or more fluid selections to be dispensed and mixed within an exemplary fluid receiving container. In one embodiment, pumps 316 are configured to activate and pump fluid through, for example, fluid supply hose 706 in response to PLC 314 providing a 12V DC signal to pumps 316. Likewise, valves 318 are configured to activate or open in response to PLC 314 providing a 12V DC signal to a valve coil of valves 318 thereby causing fluid to flow from, for example, fluid storage container 702 via fluid supply hose 706. Further, in this embodiment, solenoids 320 are configured to activate or extend in response to PLC 314 providing a 12V DC signal to a manifold of solenoids 320. According to the present disclosure, activating or extending solenoids 320 causes solenoids 320 to press or engage one or more buttons on a fluid dispenser such as exemplary dispenser 902 shown in the illustrative embodiment of FIG. 9. As described herein, dispenser 902 is operative to selectively dispense one or more different fluids, such as soda and/or water, based on the engaged input devices (buttons) actuated by solenoids 902.

In one embodiment, a plurality of valves 318 are disposed within an interior of base 110. Each of the plurality of valves 318 includes an inlet and an outlet. One end of first exemplary fluid supply hose may be coupled to a fluid outlet of pump 600 while the other end of the first exemplary fluid supply hose may be coupled to the inlet of one of the plurality of valves 318. Likewise, one end of a second fluid supply hose may be coupled to the outlet of one of plurality of valves while the other end of the second fluid supply hose is received into a portion of outlet 104. As noted above, valves 318 may be configured to activate or open in response to PLC 314 providing a 12V DC signal to a valve coil of valves 318 thereby causing fluid moving under the influence of pump 600 to flow, via the second supply hose, past valve 318 toward outlet 104. Hence, when valve 318 is open fluid moves or flows past valve 318 toward outlet 104 and when valve 318 is closed fluid flow past valve 318 toward outlet 104 is blocked. In one embodiment, each fluid storage container 702 is coupled to an exemplary fluid supply hose that provides a flow medium for fluid to flow from container 702, through pump 600, through valve 318, and toward outlet 104. Similarly, in one embodiment, a plurality of valves 318 and a plurality of pumps 600 may be disposed within an internal section of base 110 wherein a single pump 600 and a single valve 318 are utilized to move and direct the flow of a particular type of fluid from a single container 702 toward outlet 104. Hence, in one embodiment, a first pair comprising a single pump 600 and a single valve 318 are used to move and direct flow of a first fluid type while a second pair comprising a single pump 600 and a single valve 318 are used to move and direct flow of a second fluid type. Moreover, in various embodiments, one or more fluid supply hoses are received by an interior portion of outlet 104 such that fluid flows out of outlet 104 and into an exemplary fluid receiving container.

In various embodiments, pressure switch 328 of FIG. 3 cooperates with air compressor 322 to increase the likelihood that air pressure within an exemplary air hose, such as hose 706 of FIG. 7A for example, stays above a threshold air pressure. In one embodiment, pressure switch 328 provides at least two output signals that are received by PLC 314. One signal indicates a high air pressure is present within the air hose, while the other signal indicates that low air pressure is present within the air hose. Hence, during operation, pressure switch 328 will send a first signal to PLC 314 when the air pressure is too low (i.e., below a threshold value) and pressure switch 328 will send a second signal to PLC 314 when the air pressure is sufficiently high (i.e., above the threshold value). In one embodiment the threshold pressure value is 75 PSI. When pressure switch 328 provides the first signal to PLC 314, PLC 314 will respond by providing a control signal (e.g., a 12V DC signal) to compressor 322 to cause compressor 322 to activate or turn-on and begin supplying compressed air thereby increasing the pressure within the air hose. When the air pressure increases above the low pressure threshold value, pressure switch 328 will provide the second signal to PLC 314 to cause PLC 314 to no longer provide the control signal to compressor 322 thereby shutting off compressor 322. In one embodiment, PLC 314 may be programmed such that PLC 314 will not provide the control signals to pumps 316 while PLC 314 provides the control signal that turns-on compressor 322. Hence, while compressor 322 is activated and in operation, bar 100 will not dispense any fluid selections made by the user.

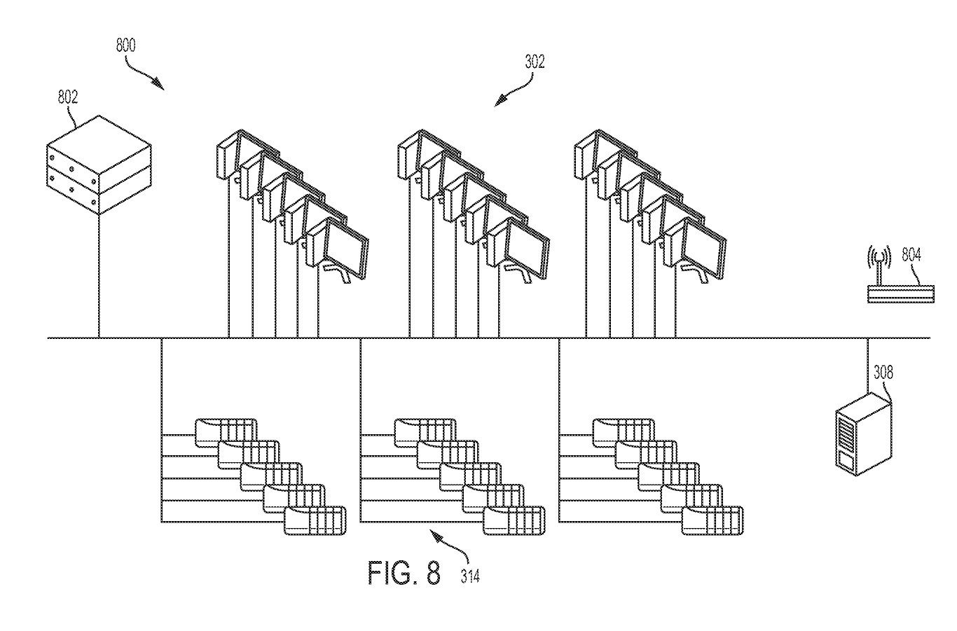

Referring now to FIG. 8, an exemplary large scale network schematic 800 is illustrated. Schematic 800 includes a plurality of displays 302, a plurality of PLCs 314, at least one computing device 308, a central server 802 and a wireless router 804. In one embodiment, a single PLC 314 and a single display 302 may be utilized to operate different bars 100. As described above in the disclosed embodiment of FIGS. 2 and 3, PLC 214, 314 may communicate user input data, fluid selection data, dispensed fluid data, system status information, or a combination thereof to a computing device or remote server device for analysis and/or storage. The computing network may include a local area network, a public switched network, a closed area network, a wide area network and any other type of wired or wireless computing network. In the illustrative embodiment of FIG. 8, schematic 800 may be used monitor various system data, system performance metrics, or system status information for multiple automatic liquor dispensers 100 distributed within a defined area. In one embodiment, a plurality of bars 100 may be distributed within a stadium or sports area wherein multiple displays 302 and PLCs 314 are networked within a local or wide area network and configured to transmit various system data and status information to a central server 802 via, for example, wireless router 804.

Referring now to the illustrative embodiment of FIG. 9, dispenser layout 900 is illustrated including a dispenser 902. In one embodiment, dispenser 902 is a conventional fluid dispensing gun used in a variety of restaurants and other establishments for dispensing various liquids such as varieties of soda, water, fruit drinks, etc. As illustrated in FIG. 9, dispenser 902 includes buttons 904, dispenser hose 906, and outlet 908. In one embodiment, dispenser 902 includes 10 or fewer buttons 904, while in an alternative embodiment dispenser 902 includes 10 or more buttons 904. Outlet 908 couples to dispenser 902 via a threaded connection however in various alternative embodiments of the present disclosure, other coupling methods may be used. Dispenser hose 906 has a diameter that is sufficiently large so as to enclose a plurality of fluid supply hoses that supply different fluids (e.g., soda, water, fruit drinks, etc.) from a plurality of different fluid storage containers or water sources. In one embodiment, and as is known in the art, a particular button may cooperate with a particular fluid supply hose to dispense a particular fluid selection. In one embodiment, dispenser 902 is used to dispense the soda, water, fruit drink, and/or other liquid that is used as a mixer in combination with one or more alcoholic beverages, and the fluid output from dispenser 902 is routed through outlet 104.

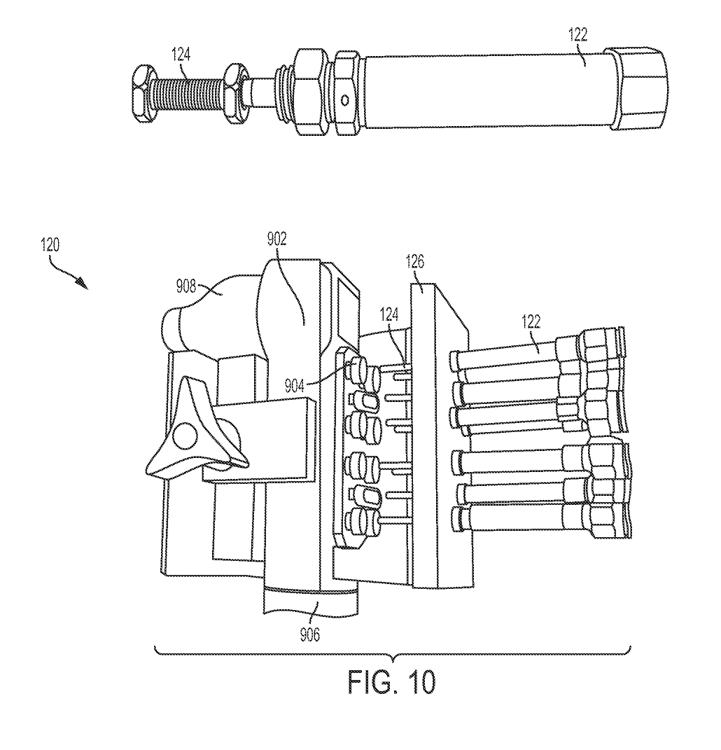

FIG. 10 illustrates an enlarged view of an exemplary solenoid 122 and an enlarged view of a physical representation of dispenser 902 coupled to a solenoid apparatus that includes a plurality of solenoids 122 used to engage a plurality of buttons 904 on dispenser 902. Solenoid 122 is a physical representation of the functional block shown as solenoid 320 in the disclosed embodiment of FIG. 3. As illustrated in FIG. 10, solenoids 122 are affixed within openings of a retaining member or wall 126 that is structured to retain dispenser 902 at a fixed distance from each extender or cylinder 124 disposed at one end of the each solenoid 122. Thus, retaining member 126 facilitates mounting solenoids 122 adjacent dispenser 902 such that extenders 124 can engage buttons 904 when solenoids 122 are activated by a control signal provided by PLC 314 (i.e., physical PLC 402). When a user inputs a desired fluid selection via display 302 (e.g., physical display 102) that requires fluid from dispenser 902, display 302 conveys the user selection to PLC 314 and PLC 314 provides control signal(s) to one or more electrical solenoids 122 to cause solenoids 122 to activate so that extender or cylinder 124 extends and engages buttons 904 to cause outlet 908 to dispense the fluid selection desired by the user. Depending on the drink selection, PLC 314 also simultaneously sends a control signal to pumps 316 (e.g., physical pump 600) to output the appropriate alcoholic fluid that is to be mixed with the fluid from dispenser 102. As described above, solenoids 122 may be configured to activate causing extender 124 to extend in response to PLC 402 providing a 12V DC signal to a manifold of solenoids 122. In another embodiment, solenoids 122 are mechanical solenoids that are pneumatically driven by an air compressor, such as compressor 322 controlled by PLC 314, for actuating cylinders 124. Exemplary solenoids 122 include Air Cylinders model number CJ2B6-10SR manufactured by SMC Pneumatics.com.

FIGS. 11A-11D each show exemplary user interfaces viewable on a display 102 of bar 100 (FIG. 1). As illustrated in FIG. 11A, user interface 150 includes a plurality of selectable user inputs or selectable data 152 corresponding to a plurality of drink selections containing alcohol and at least one selectable user input 154 corresponding to a fluid selection that does not contain alcohol (e.g., water). User interface 150 further includes a selectable edit input 155 wherein user selection of edit 155 allows a user to edit or modify data displayed within user interface 150 such as the arrangement of or drink options provided with inputs 152. Each fluid selection 152 and 154 are selectable user inputs that may be selected when the user touches a particular section of display 102 that displays the desired fluid selection. Alternatively, a mouse pointer or other user input device may be used to select the inputs 152, 154. As described above, selection of one or more selectable user inputs 152, 154 corresponding to a fluid selection causes bar 100 to dispense (and mix if a mixed drink) the selected fluid(s). In one embodiment, fluid selections 152 include a plurality of distinct fluid selections wherein one or more fluid selections contain a mix of alcoholic and non-alcoholic fluids. In this embodiment, exemplary fluid selections 152 include mixed alcoholic beverages such as Jack Daniels and Sprite, Vodka and Diet Cola, Jack Daniels and Cola, and Vodka and Lemonade. In yet another embodiment, one or more fluid selections 152 include a single shot of alcohol such as a Fireball shot or a Vodka shot. In one embodiment, selection of an input 152 or 154 causes the displayed box to display an indication (e.g., the word “pouring”) to the user that the selected drink is being poured. In one embodiment, drinks indicated with inputs 152 that are unavailable or have empty supply containers are indicated as such with a suitable indicator, such as a grayed or crossed out display box.

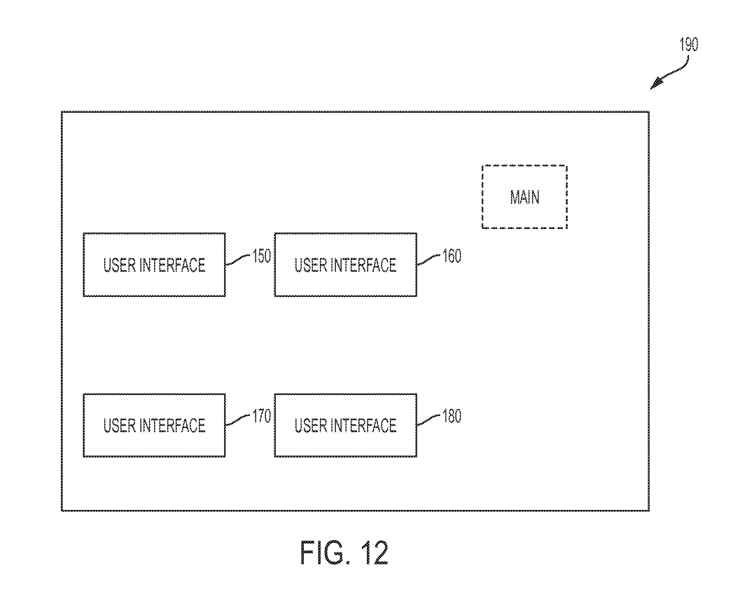

The illustrative embodiment of FIG. 11B shows an exemplary user interface 160 including additional selectable user inputs 165-168 while also including the same fluid selection inputs 152, 154 of FIG. 11A. User interface 160 further includes a plurality of non-fluid selections such as main menu 165, refill liquor 166, cash transactions or point of sale 167, and administrative screen 168. In one embodiment, selection of main menu 165 causes display 102 to display user interface 190 as shown in the illustrative embodiment of FIG. 12. Cash out input 167 navigates the display to a cash out program for charging the customer for the ordered drinks (e.g., credit card feature, cash, etc.). Administration screen input 168 is selected to enter a password protected program module for performing administrative changes to bar 100.

The illustrative embodiment of FIG. 11C shows an exemplary user interface 170 including a plurality of selectable user inputs or selectable data 172 corresponding to a plurality of alcohol-only fluid selections and a plurality of selectable user inputs 174, 176 corresponding to a fluid selections that do not contain alcohol. User interface 170 further includes a selectable input corresponding edit 155 wherein user selection of edit 155 allows a user to edit or modify data displayed within user interface 170. In one embodiment, fluid selections 172 include a plurality of liquor selections wherein exemplary selections include, Vodka, Tequila, Rum, and Whisky. In another embodiment, fluid selections 174 include a plurality of mixer selections wherein exemplary mixers include Coke, Sprite, Lemonade, Tea, Red Bull, Water, Juice, Tonic and Sour mix. In yet another embodiment, fluid selections 176 include a plurality of splash selections wherein exemplary selections include Sour mix, Juice, Grenadine, Soda, and Water. In one embodiment, fluid selections 174, 176 correspond to one or more fluids provided with dispenser 902 of FIG. 9.

The illustrative embodiment of FIG. 11D shows an exemplary user interface 180 including a plurality of data input blocks that allow a user to edit an existing fluid selection or modify one or more operational parameters of, for example, system 300 used within bar 100. In one embodiment, user interface 180 is accessible via administration screen input 168 of FIG. 11B. User interface 180 further includes a selectable input 165 corresponding the main menu and a configuration menu input 189. In one embodiment, user selection of main menu 165 causes display 102 to display user interface 190 as shown in the illustrative embodiment of FIG. 12. User selection of configuration menu 189 causes display 102 to display a user interface corresponding to a system configuration menu. In one embodiment the operational parameters include valve number 182, valve timer 184, pusher/solenoid number 186, and pusher timer 186. Each operational parameter is adjustable for each drink provided with bar 100 (i.e., the drink indicated in the MIX 1 NAME box). In one embodiment, the data input block corresponding to valve timer 184 allow a user to modify the amount of time that the appropriate valve stays open to permit the corresponding alcoholic beverage to be dispensed for the particular drink mix. Likewise, the data input block corresponding to pusher timer 188 allows a user to modify the amount of time that a particular pusher or solenoid extends and engages one or more buttons 904 of dispenser 902 (FIG. 9) for the particular drink for dispensing the mixer fluid. Hence, by increasing the amount of time a pusher extends and engages buttons 904 and the valve releases the alcohol, a user thereby adjusts the mixture amounts and the total quantity of fluid that is dispensed by bar 100. In another embodiment, a user may edit an existing fluid selection by modifying the valve number 182 and pusher number 186 that are activated when the user selects a fluid selection corresponding to, for example, Jack Daniels and Sprite. As such, the system may be configured such that the appropriate fluids are dispensed depending on which pump or valve each alcoholic beverage container is coupled to and which button 904 of dispenser 902 each solenoid engages.

The illustrative embodiment of FIG. 12 illustrates a main menu 190 including a plurality of selectable user inputs corresponding to user interface 150, 160, 170 and 180 of FIGS. 11A-11D. Accordingly, selection of user interface 150 causes display 102 to display user interface 150 as shown in the illustrative embodiment of FIG. 11A, selection of user interface 160 causes display 102 to display user interface 160 as shown in the illustrative embodiment of FIG. 11B, selection of user interface 170 causes display 102 to display user interface 170 as shown in the illustrative embodiment of FIG. 11C, and selection of user interface 180 causes display 102 to display user interface 180 as shown in the illustrative embodiment of FIG. 11D.

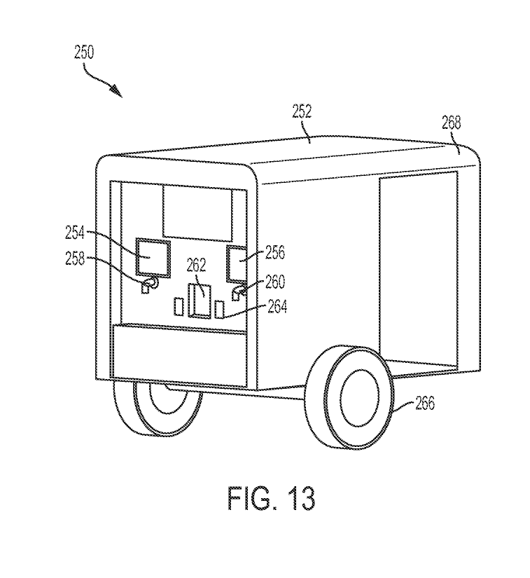

FIG. 13 illustrates an exemplary automatic fluid dispenser 250 disposed in a mobile serving structure 252 including one or more wheels 266 to facilitate movement of mobile serving structure 252 according to the present disclosure. Automatic fluid dispenser 250 and mobile serving structure 252 may also be referred to as mobile bar 250 or mobile structure 252, respectively. Mobile structure 252 generally includes a first display 254, a second display 256, a first dispenser 258, a second dispenser 260, an ice dispenser cavity 262, a scanning device 264, and a storage section 268. Mobile bar 250 includes substantially the same systems and components as described in the illustrative embodiments of FIG. 1-FIG. 12, except that mobile bar 250 includes multiple displays 254, 256 and dispensers 258, 260. As such, multiple drinks may be dispensed simultaneously from mobile bar 250. In one embodiment, storage section 268 provides the enclosure that holds the plurality of components that comprise mobile bar 250. Storage section 268 encloses a plurality of components such as, for example, one or more PLCs 402, terminal blocks 410, computing device 308, pumps 600, one-way check valves 610, solenoids 122, compressor 322, pressure sensor 328, dispenser 902, fluid storage container 702, 720, and fluid supply hose 706. In one embodiment, one or more systems 300 (FIG. 3) reside within and are enclosed by storage section 268.

In one embodiment, mobile bar 250 operates as follows: a user places an RID tag (not shown) in close proximity to scanning device 264 such that device 264 may scan the RID tag; if scanning device 264 identifies the RID tag as a known device then the user may input a desired fluid selection to at least one of first display 254 and second display 256; displays 254, 256 receive a fluid selection from the user and communicates the user's selection to PLC 402 and to other networked devices such as computing device 308 via the Ethernet protocol; PLC 402 receives the user's selection and based on that selection provides control signals to selectively activate or turn-on appropriate pumps 600 and valves 318 and actuate or extend appropriate solenoids 122 for a predetermined amount of time to allow for the desired fluid selection(s) to be dispensed from at least one of first dispenser 258 and second dispenser 260.

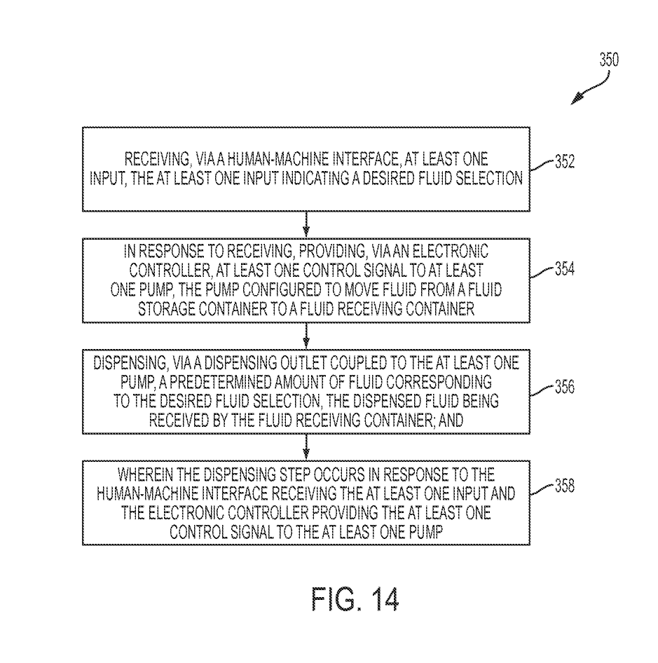

FIG. 14 shows a flow diagram of an exemplary method of operating the automatic fluid dispenser of FIG. 1 and the automatic fluid dispenser of FIG. 13 according to the present disclosure. At block 352, bar 100 receives, via a human-machine interface such as display 102, at least one user input 304, the at least one user input 304 indicating a desired fluid selection. Method 350 then proceeds to block 354 and in response to receiving, bar 100 provides, via an electronic controller such as PLC 402, at least one control signal to at least one pump 600, wherein pump 600 is configured to move fluid from fluid storage container 702 to a fluid receiving container (e.g., a glass or cup). At block 356, bar 100 dispenses, via a dispensing outlet such as outlet 104 coupled to at least one pump 600, a predetermined amount of fluid corresponding to the desired fluid selection, the dispensed fluid being received by the fluid receiving container. As indicated with block 358, the dispensing step occurs in response to display 102 receiving the at least one input 304 and the PLC 402 providing the at least one control signal to at least one pump 600.

The term “logic” or “control logic” as used herein may include software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the embodiments, various logic may be implemented in any appropriate fashion and would remain in accordance with the embodiments herein disclosed.

In the foregoing specification, specific embodiments of the present disclosure have been described. However, one of ordinary skill in the art will appreciate that various modifications and changes can be made without departing from the scope of the disclosure as set forth in the claims below. Accordingly, the specification and figures are to be regarded in an illustrative rather than a restrictive sense. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

1. An automatic fluid dispenser comprising:
a housing;
an electronic controller disposed within the housing;
a dispensing outlet coupled to the housing;
a plurality of pumps coupled to the electronic controller and positioned within the housing, wherein each pump is configured to move a different alcoholic fluid from a corresponding fluid storage container to the dispensing outlet;
a dispenser device including a plurality of selectable inputs corresponding to a plurality of non-alcoholic fluids, the dispenser device being operative to move a non-alcoholic fluid to the dispensing outlet based on selection of a selectable input; and
an interface supported by the housing and in communication with the electronic controller, the interface configured to receive one or more inputs wherein at least one of the inputs causes the electronic controller to provide a signal to at least one pump to cause movement of an alcoholic fluid from the fluid storage container to the dispensing outlet and a signal to the dispenser device to cause movement of the non-alcoholic fluid to the dispensing outlet, the dispensing outlet being configured to simultaneously dispense a predetermined amount of the alcoholic fluid and a predetermined amount of the non-alcoholic fluid to a fluid receiving container.

2. The automatic fluid dispenser of claim 1, wherein the interface includes a graphical user interface operative to display data representative of a plurality of beverage options, wherein the plurality of beverage options include a plurality of alcoholic beverage options and the one or more inputs correspond to a desired beverage option.

3. The automatic fluid dispenser of claim 1, wherein the plurality of selectable inputs of the dispenser device include a plurality of buttons wherein each button corresponds to a different non-alcoholic fluid.

4. The automatic fluid dispenser of claim 3, further including a cylinder electronically controlled by the electronic controller and disposed adjacent at least one of the plurality of buttons, the cylinder being configured to engage the at least one button in response to receiving a control signal from the electronic controller to dispense the non-alcoholic fluid corresponding to the at least one button.

5. The automatic fluid dispenser of claim 4, further including a compressor coupled to the electronic controller and coupled to the at least one cylinder, the compressor configured to provide compressed air to the cylinder wherein the compressed air has a pressure of at least 75 pounds per square inch (“PSI”).

6. The automatic fluid dispenser of claim 5, further including a pressure sensor coupled to an air supply line of the compressor and in communication with the electronic controller, the pressure sensor configured to provide a signal to the electronic controller corresponding to a pressure within the air supply line.

7. The automatic fluid dispenser of claim 6, wherein the electronic controller includes logic operative to provide a control signal to activate the compressor in response to the pressure within the air supply line falling below a predetermined threshold pressure.

8. The automatic fluid dispenser of claim 1, further including a valve electrically coupled to the electronic controller and coupled to an outlet of the fluid storage container, the valve being moveable between an opened position and a closed position in response to the electronic controller providing one or more control signals to a valve coil of the valve.

9. The automatic fluid dispenser of claim 1, wherein the serving structure includes a base and a counter, the counter being disposed atop the base and the base including one or more compartments structured to receive one or more components therein, wherein the one or more components include the electronic controller, the at least one pump, and at least one fluid storage container.

10. An automatic fluid dispenser comprising:
an electronic controller;
at least one pump coupled to the electronic controller, the at least one pump configured to move a first fluid from a first fluid storage container to an outlet;
a dispenser device including a plurality of selectable inputs corresponding to a plurality of fluids, the dispenser device being operative to move a second fluid to the outlet in response to a selection of a selectable input;
a user interface coupled to the electronic controller, the user interface including a display and being configured to receive a user input corresponding to a fluid mixture selection and to output a signal indicative of a fluid mixture selection; and
a scanning device communicably coupled to the electronic controller and the display, the scanning device configured to identify a known device;
wherein the electronic controller is operative to provide one or more control signals to the at least one pump and to the dispenser device to cause the automatic fluid dispenser to dispense a predetermined amount of the first fluid and a predetermined amount of the second fluid through the outlet in response to the scanning device identifying the known device and the user interface providing the signal indicative of the fluid mixture selection.

11. The automatic fluid dispenser of claim 10, wherein the user interface is a graphical user interface operative to display data representative of a plurality of alcoholic beverage options, wherein the fluid mixture selection corresponds to a desired alcoholic beverage option.

12. The automatic fluid dispenser of claim 11, wherein the user interface provides one or more inputs to the electronic controller based on the scanning device identifying the known device, and the electronic controller provides the one or more control signals to the at least one pump and to the dispenser device in response to the user interface providing the one or more inputs.

13. The automatic fluid dispenser of claim 10, further including a computing device coupled to the electronic controller and the user interface, the computing device configured to receive signals from the user interface and to receive control signals from the electronic controller wherein the control signals cause the computing device to transmit data to an external server, the data indicating at least one input received by the user interface indicative of the fluid mixture selection.

14. The automatic fluid dispenser of claim 13, wherein the computing device includes at least one memory module configured to store at least one input received by the user interface and to store data indicating one or more fluid mixture selections.

15. The automatic fluid dispenser of claim 14, wherein the electronic controller, the display, the computing device, the scanning device, and the external server, reside on a local area network and exchange data communications by way of the Ethernet network communications protocol.

16. A fluid dispensing system comprising:
at least one processor;
memory containing instructions that when executed by the at least one processor cause the at least one processor to provide a first user interface viewable on a display, the first user interface comprising selectable data representing a plurality of fluid selections including at least one of an alcoholic fluid mixture selection and a non-alcoholic fluid selection;
at least one pump in communication with the processor, the at least one pump configured to move an alcoholic fluid from a fluid storage container to an outlet based on a user selection of an alcoholic fluid mixture selection provided via the first user interface; and
a dispenser device operative to move a non-alcoholic fluid to the outlet based on the user selection of the alcoholic fluid mixture selection provided via the first user interface,
wherein the processor is operative to provide one or more control signals to the at least one pump and to the dispenser device to cause the automatic fluid dispenser to simultaneously dispense a predetermined amount of the alcoholic fluid and a predetermined amount of the non-alcoholic fluid through the outlet in response to the user selection of the alcoholic fluid mixture selection provided via the first user interface.

17. The fluid dispensing system of claim 16, wherein the dispenser device includes a plurality of input buttons and a plurality of solenoid assemblies configured to engage the plurality of input buttons, the processor being operative to provide a control signal to at least one solenoid assembly to engage an input button corresponding to the non-alcoholic fluid based on the user selection of an alcoholic fluid mixture selection.

18. The fluid dispensing system of claim 16, the at least one processor being further configured to provide a second user interface viewable on the display, the second user interface comprising selectable data representing a plurality of alcoholic fluid selections and at least one non-fluid selection.

19. The fluid dispensing system of claim 16, wherein selection of the selectable data representing the non-fluid selection causes the processor to provide a third user interface viewable on the display, the third user interface operative to provide user access to modify one or more operational parameters of the fluid dispensing system, the operational parameters including at least one of a duration of a valve opening event, a duration of a pump operation event, and a duration of a dispensing event of dispenser device.

20. A method in a fluid dispensing system comprising the steps of:
receiving, via a human-machine interface, at least one input, the at least one input indicating a desired fluid mixture selection;
in response to the receiving, providing, via an electronic controller, at least one control signal to at least one pump, the pump configured to move a first fluid from a fluid storage container to an outlet;
in response to the receiving, providing, via the electronic controller, at least one control signal to a dispenser device, the dispenser device being operative to move a second fluid to the outlet; and
dispensing, via the outlet, a predetermined amount of the first fluid and a predetermined amount of the second fluid corresponding to the desired fluid mixture selection, the dispensed fluid mixture being received by the fluid receiving container.
